(19) United States
(12) Patent Application Publication
(10) Pub. No.: US 2026/0052445 A1
(43) Pub. Date: Feb. 19, 2026

(54) NETWORK INFORMATION HOSTING METHOD AND DEVICE USING STEERING OF ROAMING IN WIRELESS COMMUNICATION SYSTEM

(71) Applicant: SAMSUNG ELECTRONICS CO., LTD., Suwon-si, Gyeonggi-do (KR)

(72) Inventors: Naman GUPTA, Suwon-si (KR); Kisuk KWEON, Suwon-si (KR)

(21) Appl. No.: 19/102,317

(22) PCT Filed: Aug. 8, 2023
(86) PCT No.: PCT/KR2023/011703

§ 371 Date: Feb. 7, 2025

(30) Foreign Application Priority Data
Aug. 9, 2022 (KR) 10-2022-0099363

(51) Int. Cl. H04W 36/14; H04W 8/12; H04W 36/00

(52) U.S. Cl. CPC H04W 36/14; H04W 8/12; H04W 36/0055

(57) ABSTRACT

The present disclosure relates to a 5G or 6G communication system for supporting higher data transmission rates. A method of a network entity included in a home network in a wireless communication system, according to one embodiment of the present disclosure, comprises the steps of receiving first steering of roaming (SoR)-related terminal information from a serving network to which a terminal is connected; determining, on the basis of the first SoR-related terminal information, whether to steer the terminal to a hosting network that provides a localized service; and transmitting first SoR information to the terminal through the serving network, if it is determined that the terminal will be steered to the hosting network that provides the localized service, wherein the first SoR information includes an indication that the terminal is to be switched into a localized service access mode.

### TECHNICAL FIELD

The disclosure relates to a method and device for a network information hosting procedure via steering of roaming (SoR) in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

### DETAILED DESCRIPTION OF THE INVENTION

### Technical Problem

Disclosed embodiments provide a method and device for triggering a steering of roaming (SoR) procedure based on a user equipment's (UE's) current parameter (UE location, service, quality, the total number of subscriber UEs in a corresponding area, or the like) in association with the UE that is roaming in a wireless communication system.

Disclosed embodiments provide defining additional information that may be included in SoR information so that a UE is capable of accessing a localized service and/or home network service via a hosting network.

Disclosed embodiments provide defining additional parameters to be used when a home network determines and selects a UE to be steered to a hosting network for the availability of a localized service.

Disclosed embodiments provide a method and device for using, by a UE, steering of roaming (SoR) information related to a hosting network, which is received from a home network in a wireless communication system.

Disclosed embodiments provide a method in which a UE returns to a serving network or a home network when a hosting network does not provide a service any longer.

### Technical Solution

According to an embodiment, a method of a network entity included in a home network in a wireless communication system may include an operation of receiving first steering of roaming (SoR)-related UE information from a serving network to which a UE is connected, an operation of determining, based on the first SoR-related UE information, whether to perform steering of the UE to a hosting network that provides a localized service, and an operation of transmitting first SoR information to the UE via the serving network when steering of the UE to the hosting network that provides the localized service is determined to be performed, and the first SoR information may include an indication associated with the UE's switching to a localized service access mode.

According to an embodiment of the disclosure, a network entity included in a home network in a wireless communication system may include a transceiver and at least one processor, and the at least one processor is configured to receive first SoR-related UE information from a serving network to which a UE is connected, to determine, based on the first SoR-related UE information, whether to perform steering of the UE to a hosting network that provides a localized service, and to transmit first SoR information to the UE via the serving network when steering of the UE to the hosting network that provides the localized service is determined to be performed, and the first SoR information may include an indication associated with the UE's switching to a localized service access mode.

### Advantageous Effects

The disclosure provides session continuity when a user equipment (UE) moves to a hosting network from a serving network, or vice versa, via network information hosting using steering of roaming (SoR), thereby improving quality of service.

### BRIEF DESCRIPTION OF DRAWINGS

FIG. 1 is a diagram illustrating a localized service provided by a hosting network;

FIG. 2 is a diagram illustrating steering, by a home network, a user equipment (UE) to a hosting network in a serving network service area according to an embodiment of the disclosure;

FIG. 3 is a diagram illustrating an operation of establishing a service relationship between a home network and a hosting network according to an embodiment of the disclosure;

FIG. 4 is a flowchart illustrating a procedure of steering a UE to a hosting network according to an embodiment of the disclosure;

FIG. 5 is a flowchart illustrating a procedure of steering a UE to a hosting network when the hosting network is a PNI-NPN according to an embodiment of the disclosure;

FIG. 6 is a flowchart illustrating a procedure in which a UE returns to a serving network or a home network after a steering procedure according to an embodiment of the disclosure;

FIG. 7 is a flowchart illustrating a procedure in which a UE returns to a serving network or a home network after a steering procedure when service continuity is not supported between a hosting network and the serving network according to an embodiment of the disclosure;

FIG. 8 is a flowchart illustrating a procedure in which a UE returns to a serving network or a home network after a steering procedure when service continuity is supported between a hosting network and the serving network according to an embodiment of the disclosure;

FIG. 9 is a diagram illustrating operation of a network entity according to an embodiment; and

FIG. 10 is a diagram illustrating a structure of a network entity according to an embodiment of the disclosure.

### MODE FOR CARRYING OUT THE INVENTION

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

As used herein, each of such phrases as “A/B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, or other similar services.

In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the disclosure, terms and names defined in 5GS and new radio (NR) standards, which are standards specified by the 3rd generation partnership project (3GPP) group among the existing communication standards, are used for the sake of descriptive convenience. However, the disclosure is not limited to the above terms and names, and may be applied to wireless communication networks conforming to other standards.

Hereinafter, terms used in the disclosure will be described.

“Public land mobile network (PLMN)” refers to a network deployed and operated by a mobile network operator. Each mobile network operator may operate one or more PLMNs. Each PLMN may be identified based on a mobile country code (MCC) and a mobile network code (MNC). PLMN information of a cell may be included in system information and broadcasted. In the case of PLMN selection, cell selection, and cell reselection, various types of PLMNs may be taken into consideration by a user equipment (UE).

“Home PLMN (HPLMN)” refers to a PLMN having an MCC and an MNC that match an MCC and an MNC of a UE IMSI.

“Equivalent HPLMN (EHPLMN)” refers to a PLMN that is regarded as equivalent to an HPLMN.

Each mobile service consumer subscribes to an HPLMN. When a general service is provided to a UE via an HPLMN or an EHPLMN, the UE is not in a roaming state.

“Visited PLMN (VPLMN)” refers to a PLMN, excluding an HPLMN/EHPLMN. When a service is provided to a UE via a visited PLMN (VPLMN), the UE is in a roaming state.

When power is turned on at an initial stage, a UE searches for a public land mobile network (PLMN) available and selects a PLMN appropriate for receiving a service. The PLMN is a network deployed or operated by a mobile network operator. Each mobile network operator may operate one or more PLMNs. Each PLMN may be identified based on a mobile country code (MCC) and a mobile network code (MNC).

“Localized service” is a service provided in a predetermined or a restricted area and/or a service having a time restriction. The service may be provided in the form of an application (electronic game, audio/video on demand, or the like) or in the form of a simple connection (a UE may provide better QoS via a data network).

“Hosting network” is a network that provides access to a localized service, and generally, is a stand-along non-public network (SNPN). The hosting network may be used for providing a home network service to a UE. Alternatively, the hosting network is a public network integrated-NPN (PNI-NPN), and may use the whole or part of a PLMN of a serving network, unlike an SNPN.

“PLMN access mode” refers to a mode in which a UE searches for and selects a PLMN to use, and attempts to register with the same, based on a prioritized PLMN list stored in the UE.

“Steering of roaming (SoR)” is a procedure in which an operator (home network) enables a UE that is in a roaming state to connect to a corresponding hosting network. In this instance, the operator may notify the UE of a list of preferred PLMNs. In this procedure, to enable the home network to determine SoR, parameters associated with the UE that is currently in the roaming state, such as a current location of the UE, QoS, or the like.

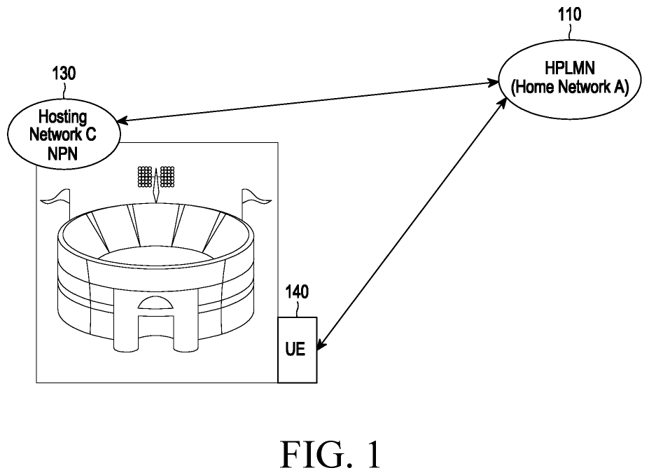

FIG. 1 is a diagram illustrating a localized service provided by a hosting network.

Referring to FIG. 1, a network A 110 (hereinafter, home network A) which is a home public land mobile network (HPLMN) may make a service contract with a hosting network C 130 in order to provide a UE 140's access to a service of the hosting network C 130.

For example, in a stadium having high congestion, when an event occurs of which the quality of service by the hosting network C 130 is good, the home network A 110 may perform steering of some UEs 140, which receive the service, to the predetermined hosting network C 130 in order to access a specialized localized service or a service with better quality.

This may be applicable in the case in which the UE 140 is in a roaming state and is connected to a serving network. The home network A 110 may steer the UE 140 to the hosting network C 130 based on a location of the UE 140 or the quality of service received by the UE 140. Information including the location of the UE 140 and the quality of service received by the UE 140 may be provided from the home network A 110 to the UE 140 via a current serving network of the UE 140.

A 5G system may need to provide session continuity to a user when the user moves from a serving network to a hosting network or vice versa, so as to provide a seamless service during the movement.

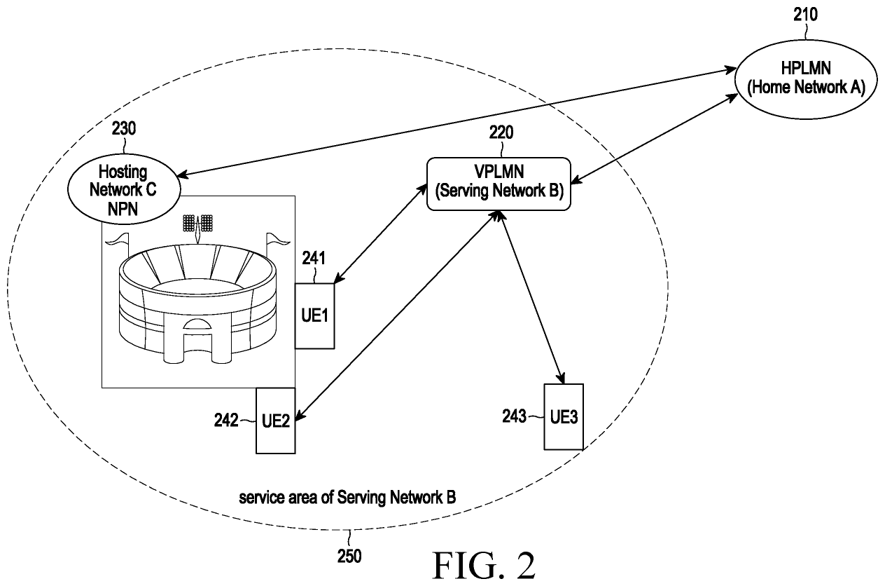

FIG. 2 is a diagram illustrating steering, by a home network, a UE to a hosting network in a serving network service area according to an embodiment of the disclosure.

Referring to FIG. 2, an HPLMN 210 (hereinafter, home network A) may establish a relationship with each of a VPLMN 220 (hereinafter, serving network B) and a hosting network C 230 via a service contract. In addition, the hosting network C 230 in a service area 250 of the serving network B 220 located in a country X may make a service continuity contract with the serving network B 220.

In FIG. 2, the home network A 210 and the serving network B 220 are regarded as PLMNs, but the disclosure may be applicable when one or both of the networks are non-public networks (SNPN). In addition, there are multiple hosting networks that overlap an area where a serving network provides a service, and a home network may have a relationship with one or more of the hosting networks via a service contract.

According to an embodiment, subscriber UEs of the home network A 210 may be registered in the serving network B when they enter the country X. For example, in the case in which an event occurs in a predetermined stadium in the country X, a plurality of subscriber UEs 241, 242, and 243 of the home network A 210 may decide to participate in the event. In order to offer the subscribers services with better quality, a hosting network C (NPN) 230 may be installed in the stadium area, and may provide some localized services (e.g., access to an application distributed locally). According to an embodiment, the home network A 210 may determine to steer all or some of the UEs in the event area to the hosting network C 230 in order to prevent the serving network B 220 from providing a low-quality service in the corresponding area due to a large crowd.

SoR information provided in the case of access to the hosting network C 230 (a temporary service is provided and triggering is explicitly performed so that a UE makes a connection) may update an operator PLMN selector list, a preferred SNPN's credential holder list, or the like. In addition, the SoR procedure may be triggered only when a UE performs initial registration (or emergency registration) or a home network policy is changed. Therefore, there is a need for a procedure that selectively starts an SoR procedure with respect to a UE based on a location of the UE and/or an experienced service quality or the like.

For example, considering the fact that, when a UE is configured based on hosting network information during a UE's initial registration, a UE that is not to use a predetermined network at any future point in time may also store the corresponding information, this may deteriorate service efficiency. Some UEs may not join a localized service event provided by the corresponding hosting network, and may not need SoR information. The same thing happens when a home network determines to update a UE (SoR information is provided) at the same time when an event starts. In addition, this may cause a problem of not allowing the home network to freely select some UEs to steer among the UEs participating in the event. Upon occasion, the home network may determine to steer only some of the UEs participating in the event, and some other UEs may be continuously connected to a serving network.

Accordingly, during the initial registration, some additional data may be included in SoR information that is provided to enable a UE to access the hosting network for a localized service/home network service, instead of registration of information associated with the hosting network.

Table 1 given below shows SoR information that the home network A 210 provides a UE.

TABLE 1

| | |
|---|---|
| SoR | List of preferred PLMN/access technology combinations |
| Informa- | and/or Credentials Holder controlled prioritized lists of |
| tion | preferred SNPNs and GINs or |
| | HPLMN/Credentials Holder indication that no change of the |
| | above list(s) stored in the UE is needed (see NOTE 3). |
| | Optionally includes an indication that the UDM requests an |
| | acknowledgement of the reception of this information from |
| | the UE. |
| | Indication for UE to switch to Localized service access mode |
| | Subscription date for the Hosting network(s). Optionally, |
| | include the indication whether service continuity is |
| | available between Hosting network and UE's serving network |

That is, the SoR information may include the following information.
List of preferred PLMN/access technology combinations
and/or credential holder-controlled prioritized list of preferred SNPNs and GINs
HPLMN/credential holder indication indicating that no change of the above list(s) stored in a UE is needed
Indication indicating that a UDM requests an acknowledgement of reception of this information from a UE (optionally included)
Indication associated with a UE's switching to a localized service access mode
Subscription data associated with a hosting network(s) Indication associated with whether service continuity between a hosting network and a serving network of a UE is available (optionally included)

“Indication associated with a UE's switching to a localized service access mode” may perform triggering so that a UE receives this information automatically switch to a localized service access mode. This may rather support a home network to immediately steer a UE to a hosting network, instead of performing triggering by switching a UE's mode to a localized service access mode manually by a user.

In the subscription data (or hosting network information), a prioritized list of hosting networks identified based on an SNPN ID may be included. In the case in which a hosting network is an SNPN, this may be identified based on an SNPN ID. A UE may receive a temporary credential or an indication indicating that the UE is capable of performing authentication via a home network credential. Hosting network information may include an effective area and time for helping a UE select a hosting network at an appropriate time and place.

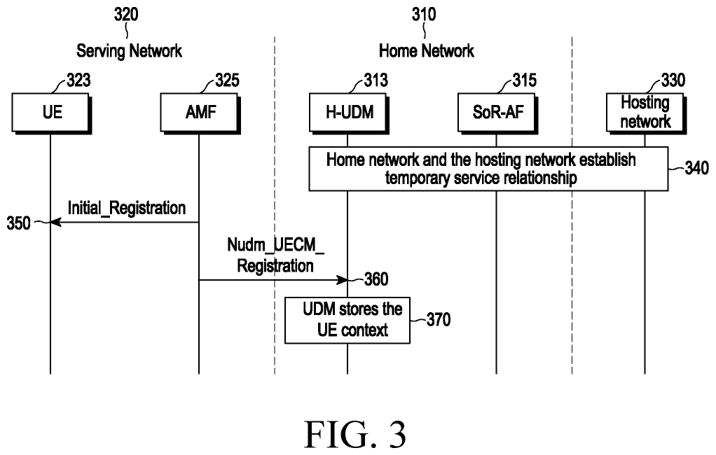

FIG. 3 is a diagram illustrating an operation of establishing a service relationship between a home network and a hosting network according to an embodiment of the disclosure.

Before performing a procedure of steering a UE to a hosting network, a home network may need to establish a service relationship with the hosting network. This may occur dynamically before an event occurs or when the home network discovers that resources of a serving network B are not enough to provide a user with a sufficient quality of service. In addition, the fact that a UE may perform initial registration with the hosting network may be taken into consideration.

FIG. 3 illustrates operation performed among a home-unified data management (H-UDM) 313 and an SoR-application function (AF) 315 included in a home network 310, a UE 323 and an access and mobility management function (AMF) 325 included in a serving network 320, and a hosting network 330.

In operation 340, a temporary service relationship between the home network 310 and the hosting network 330 may established. In operation 350, the AMF 325 may transmit an Initial_Registration message to the UE 323, so as to perform initial registration. In this instance, the serving network 320 may register the UE 323 with the serving network 320 when the UE 323 enters its service area (e.g., a country where the home network does not provide a service).

In operation 360, the AMF 325 may transmit Nudm_UECM_Registration to the H-UDM 310 of the home network 310, so as to perform a registration procedure. That is, AMF 325 (visited AMF (V-AMF)) of the serving network 320 may register itself with the home UDM (H-UDM) 313. In operation 370, the H-UDM 313 may store a UE context. Subsequently, the H-UDM 313 (or AF) may be informed that the UE exists in the serving network 320.

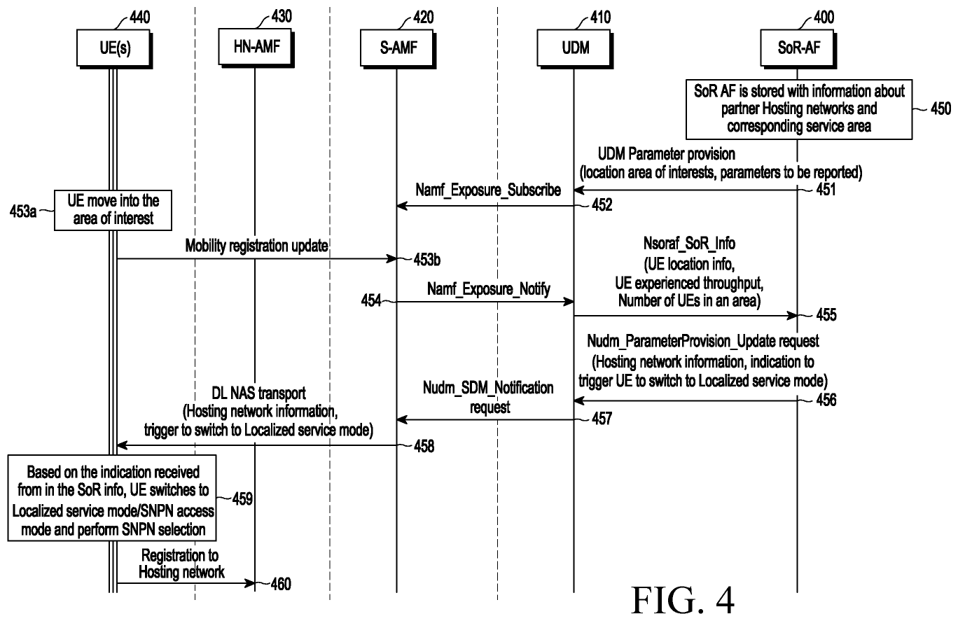

FIG. 4 is a flowchart illustrating a procedure of steering a UE according to an embodiment of the disclosure.

FIG. 4 illustrates operation performed among an SoR-AF 400 and a UDM 410 included in a home network, a serving-AMF (S-AMF) 420 included in a serving network, a hosting network-AMF (HN-AMF) 430 included in a hosting network, and at least one UE 440.

In FIG. 4, in the case of collecting data related to a subscribed UE, providing hosting network information and other data discussed below to the corresponding UE, and steering the UE to a hosting network, an SoR-AF may be replaced with a third party AF capable of performing negotiation with a UDM and a home network.

In operation 450, information associated with a partner hosting network may be stored in the SoR-AF 400 (or 3^{rd} party AF). The information associated with the partner hosting network may include an SNPN ID of the hosting network, a localized service provided thereby, a location area, a time validity, or the like.

In operation 451, the SoR-AF 400 (or 3^{rd} party AF) may perform provisioning of a UDM parameter (hosting network information and/or parameters to be reported, or the like) to the UDM 410. The UDM parameter may include at least one of the information listed below.
UE identifier
Reporting information [list]
a. Reporting ID
b. Location area of interest
c. Time validity
d. Parameter to be reported
i. UE experienced throughput/QoS(quality of service).
ii. Total number of UEs existing in an area (area of interest)

The SoR-AF 400 may provide, to the UDM 410, a notification indicating subscription of a UE's exposure information. The UE may subscribe to a plurality of localized services each of which has the UE's location/time validity and thus, it is required to distinguish information associated with the plurality of localized services. Accordingly, the information associated with the plurality of localized services may be distinguished based on an identifier named reporting ID.

In operation 452, the UDM 410 may transmit Namf_Exposure_Subscribe to the S-AMF 420 of the serving network, and may subscribe to an event and information requited by the SoR-AF 400 (3^{rd} party AF). Namf_Exposure_Subscribe may include parameters such as a location area of interest, time validity, a parameter to be reported (UE experienced throughput/QoS), and the total number of UEs existing in an area.

In operation 453a, the UE 440 may move into an area of interest. Due to mobility of the UE 440, the UE 440 may enter into an area to which the UDM is subscribing. In operation 453b, the UE 440 may request mobility registration update from the S-AMF 420. That is, the UE may perform mobility registration update and notify its current location to the S-AMF 420, or alternatively, a radio access network (RAN) may notify a current location of the UE 440 to the S-AMF 420 without a mobility registration update message explicitly transmitted from the UE 440 to the S-AMF 420.

In operation 454, the S-AMF 420 may transmit Namf_Exposure_Notify to the UDM 410, and may notify the UDM of a current location of the UE, the number of UEs existing in an area of interest, or UE experienced throughput/QoS.

In operation 455, the UDM 410 transmits Nsoraf_SoR_Info so as to report, to the SoR-AF 400 (3^{rd} party AF), the obtained parameter such as the UE location, UE experienced throughput/QoS, or the number of UEs existing in the area of interest.

The SoR-AF 400 (3^{rd} party AF) may obtain the SoR information from a plurality of UEs, and, based on elements such as a time, a UE location, UE experienced throughput, a serving network load, or the like, the SoR-AF(3^{rd} party AF) 400 may transmit required information to the UDM 410, so that some or all of the UEs 440 to a predetermined hosting network are determined to be steered.

In operation 456, the SoR-AF 400 (3^{rd} party AF) may transmit a Nudm_ParameterProvision_Update request to the UDM 410. That is, to provide SoR information shown in Table 1 to a UE, the SoR-AF(3^{rd} party AF) may transmit the Nudm_ParameterProvision_Update request to the UDM 410. The Nudm_ParameterProvision_Update request may include subscription information associated with the hosting network (at least one of an SNPN ID list, location validity information, time validity information, and an indication associated with service continuity between the current serving network and its SNPN), and an indication associated with a UE's switching to a localized service access mode.

In operation 457, the UDM 410 may transmit a Nudm_SDM_Notification request to the S-AMF 420. That is, the UDM 410 may notify the S-AMF 420 of the SoR information obtained from the SoR-AF 400 (3^{rd} party AF). The SoR information obtained from the SoR-AF 400 (3^{rd} party AF) and notified by the UDM 410 may include subscription information associated with the hosting network (at least one of an SNPN ID list, location validity information, time validity information, and an indication associated with service continuity between the current serving network and its SNPN), and an indication associated with a UE's switching to a localized service access mode.

In operation 458, the S-AMF 420 may transmit DL NAS transport to the UE 440. That is, the S-AMF 420 may transmit the information received from the UDM to the UE 440. The SoR information that the S-AMF 420 receives from the UDM may include at least one of subscription information associated with the hosting network (at least one of an SNPN ID list, location validity information, time validity information, and an indication associated with service continuity between the current serving network and its SNPN), and an indication associated with a UE's switching to a localized service access mode.

In operation 459, the UE 440 may switch to the localized service mode (or SNPN access mode) (by using an SNPN ID in a prioritized list of hosting networks, location validity, or time validity) based on “indication associated with a UE's switching to a localized service mode” included in the SoR information, and may proceed with SNPN network selection. According to an embodiment, the UE 440 may deregister from the current serving network.

In operation 460, the UE 440 may register with the hosting network. The UE 400 may proceed with registration with the network selected by itself in operation 459 based on the hosting network information included in the SoR information received from the home network. When service continuity is supported between the hosting network and the current serving network of the UE 440 (based on “indication associated with whether service continuity is available” included in the hosting network information), the UE 400 may transmit a registration request associated with the selected hosting network, and the UE's session may be transferred from the existing serving network to the hosting network. When service continuity is not supported, the UE 400 may proceed with regular registration with the new hosting network, and may generate a new packet data unit (PDU) session in the network.

Although operations 450, 451, 452, 454, 455, 456, and 457 illustrate that the UDM 410 and the SoR-AF 400 operate as separate network entities, the UDM 410 according to an embodiment may solely perform operations 450, 451, 452, 454, 455, 456, and 457. That is, the SoR-AF 400 may be included optionally, and when the SoR-AF 400 is not included separately, the UDM 410 may perform all of the operations described as the operations of the SoR-AF 400.

Hereinafter, a method in which the UE 440 performs operation 460 will be described in detail. That is, the UE 440 may register with the hosting network in the following two cases.

Case 1. No service continuity is supported between a serving network and a hosting network.
a. The UE 440 may wait for entering an idle mode. When the UE 440 enters the idle mode, the UE 440 may switch into an SNPN access mode based on a received indication associated with a localized service, and may start SNPN selection based on received hosting network information and may register with a predetermined hosting network.
b. Alternatively, when the UE 440 is to receive a predetermined localized service (service that may not be provided by a serving network of the UE 440), the UE 440 may determine to immediately deregister from the serving network and switch into an SNPN access mode so as to register with a hosting network.

In both a and b, the UE 440 may start searching for a call/PLMN in the background before deregistering from a serving network.

Case 2. Service continuity is supported between a hosting network and a serving network.

When service continuity is supported between a serving network and a hosting network, the UE 440 may report the same via a home network (by using an indication included in hosting network information) or the current serving network. Alternatively, the UE 440 itself may attempt to perform handover directly to the hosting network, and, when it fails, may operate according to case 1 (no service continuity is supported between the serving network and the hosting network).

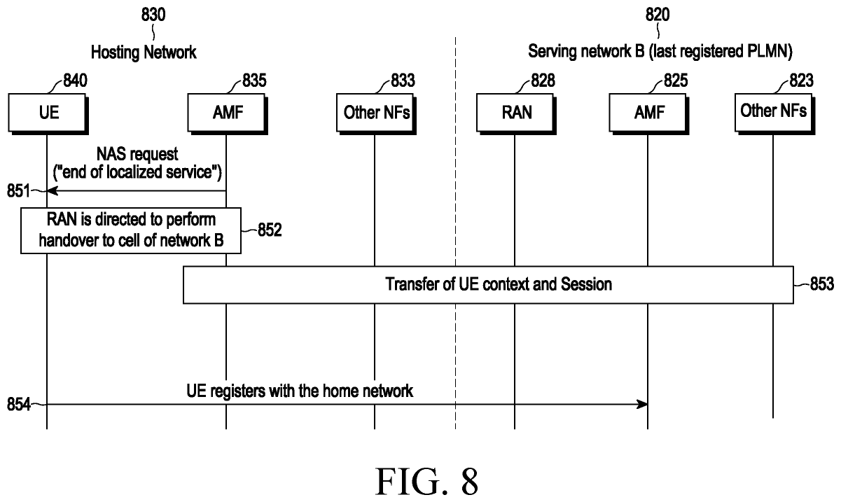

Therefore, when receiving hosting network information together with an indication indicating that service continuity is supported between the hosting network and the serving network of the UE 440, the UE 440 may be triggered to perform cell reselection and change its registered network to the hosting network. The UE 440 may scan cells that broadcast hosting network IDs in the background, and may perform handover to the corresponding cell. This is a type of UE-triggered inter-network handover by which the UE 440 may provide supported information to its source cell in order to handover to a predetermined target cell associated with a predetermined network (in this instance, the hosting network). This will be described with reference to FIG. 8.

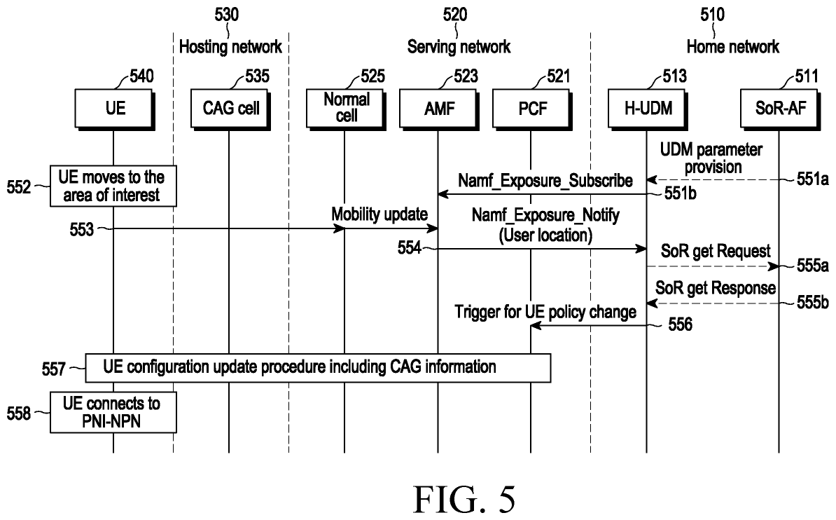

FIG. 5 is a flowchart illustrating a procedure of steering a UE according to an embodiment of the disclosure.

More specifically, FIG. 5 is the case in which a hosting network 530 is a special network, and illustrates a UE's steering procedure in the case of an integrated non-public network (PNI-NPN) supported by a serving network 520 of a UE 540. In this instance, the hosting network 530 may determine to make a contract with the serving network 520, so that a subscriber accesses the PNI-NPN. The hosting network 530 may provide closed access group (CAG) information to the UE 540 so that the UE 540 connects to the PNI-NPN. In this instance, as most cells existing around an event area broadcast CAG IDs, this may be useful when a UE that is regularly registered with the serving network 520 is incapable of receiving service with good quality in the event area of the hosting network 530.

FIG. 5 illustrates operation performed among a H-UDM 513 and an SoR-AF 511 included in a home network 510, a PCF 521, an AMF 523, and a normal cell 525 included in the serving network 520, a CAG cell 535 included in the hosting network 530, and the UE 540.

Operations 551a to 555b are the same as operations 451 to 456 of FIG. 4.

In operation 556, the H-UDM 513 (or another network function of the home network) may notify the V-PCF 521 (or another network function of the serving network) so that the V-PCF 521 provides, to the UE 540, CAG information for connecting to a PNI-NPN where a predetermined event may be distributed.

In operation 557, a UE configuration including the CAG information may be updated. In operation 558, the UE 540 may connect to the PNI-NPN hosting network.

Although operations 551a, 551b, 554, 555a, 555b, and 556 illustrate that the UDM 610 and the SoR-AF 511 operate as separate network entities, the H-UDM 513 according to an embodiment may solely perform operations 551a, 551b, 554, 555a, 555b, and 556. That is, the SoR-AF 511 may be included optionally, and when the SoR-AF 511 is not included separately, the H-UDM 513 may perform all of the operations described as the operations of the SoR-AF 511.

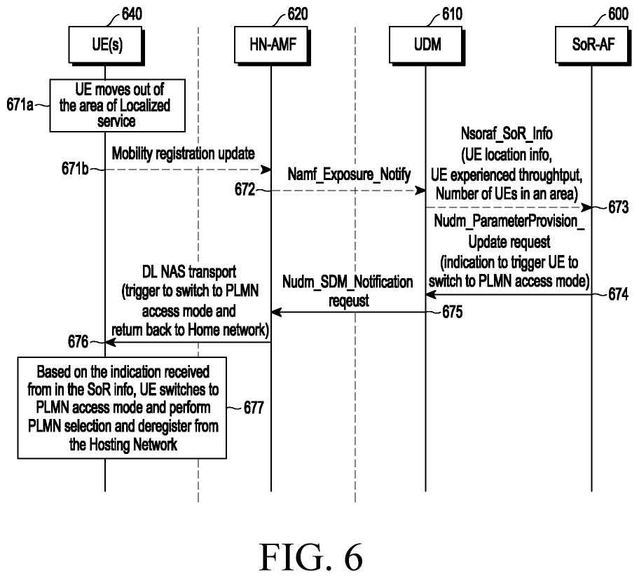

FIG. 6 is a flowchart illustrating a procedure in which a UE returns to a serving network or a home network after a steering procedure according to an embodiment of the disclosure.

FIG. 6 illustrate operation performed among an SoR-AF 600 and a UDM 610 included in a home network, a hosting network-AMF (HN-AMF) 620 included in a hosting network, and at least one UE 640. More specifically, this relates to an operation of triggering return to a serving network or a home network again, after the home network steers a UE to a hosting network in FIG. 4 and when a service of the hosting network is not needed any longer.

When a UE connects to a hosting network, the corresponding network becomes a current serving network of the UE. However, in FIG. 6, to avoid confusion, a network to which a UE is connectable after deregistering from the hosting network is referred to as a serving network. In most cases, it is the network that served the UE before the UE connects to the hosting network.

In operation 671a, the UE 640 may move outside a localized service area. That is, since the UE 640 is outside a coverage area of the hosting network, the UE 640 may perform network selection again so as to attempt to access an available network. Due to the mobility of the UE 640, a change associated with the UE 440 may occur in an area that a UDM subscribes to, and the UE 640 may request mobility registration update from the HN-AMF 620 in operation 671b. That is, the UE 640 may perform mobility registration update and notify its current location to the HN-AMF 620, or alternatively, a radio access network (RAN) may notify a current location of the UE 640 to the HN-AMF 620 without a mobility registration update message explicitly transmitted from the UE 640 to the HN-AMF 620.

In operation 672, the HN-AMF 620 may transmit Namf_Exposure_Notify to the UDM 610, and may notify the UDM of the current location of the UE, the number of UEs existing in an area of interest, or UE experienced throughput/QoS. According to an embodiment, in operation 672, the HN-AMF 620 may transmit the Namf_Exposure_Notify to the UDM 610 when a predetermined time period for a localized service provided to the UE 640 expires.

In operation 673, the UDM 610 transmits Nsoraf_SoR_Info so as to report, to the SoR-AF 600 (3^{rd} party AF), the obtained parameter such as the UE location, UE experienced throughput/QoS, the number of UEs existing in the area of interest.

The SoR-AF 600 (3^{rd} party AF) may obtain the SoR information (Nsoraf_SoR_Info) from a plurality of UEs, and based on elements such as a time, UE location, UE experienced throughput, a serving network load, or the like, the SoR-AF 600 (3^{rd} party AF) may transmit required information to the UDM 610, so that some or all of the UEs 640 may be determined to be steered to a predetermined hosting network. That is, the home network of the UE may determine that the UE does not need a localized service from the hosting network any longer, and may determine to indicate, to the UE, deregistering from the current hosting network, returning to its home network or previous serving network, and receiving a service from the network. That is, the home network may determine that the previous serving network is capable of providing a high-quality of service to the UE, or may determine to terminate the contract with the hosting network.

In operation 674, SoR-AF 600 (3^{rd} party AF) may transmit a Nudm_ParameterProvision_Update request to the UDM 610. That is, to provide SoR information shown in Table 1 to the UE, the SoR-AF 600 (3^{rd} party AF) may transmit the Nudm_ParameterProvision_Update request to the UDM 610. In this instance, unlike the Nudm_ParameterProvision_Update request illustrated in operation 456 of FIG. 4, the Nudm_ParameterProvision_Update request may not include subscription information associated with a hosting network, but may include an indication associated with a UE's switching to a PLMN access mode (indication to trigger UE to switch PLMN access mode).

In operation 675, the UDM 610 may transmit a Nudm_SDM_Notification request to the HN-AMF 620. That is, the UDM 610 may notify the HN-AMF 620 of the SoR information obtained from the SoR-AF 600 (3^{rd} party AF). Unlike the Nudm_ParameterProvision_Update request illustrated in operation 457 of FIG. 4, the SoR information obtained from the SoR-AF 600 (3^{rd} party AF) and notified by the UDM 610 may not include subscription information associated with a hosting network, but may include an indication associated with a UE's switching to a PLMN access mode (indication to trigger UE to switch PLMN access mode).

In operation 676, the HN-AMF 620 may transmit DL NAS transport to the UE 640. That is, the HN-AMF 620 may transmit the information received from the UDM 610 to the UE 640. The SoR information that the HN-AMF 620 receives from the UDM 610 may include an indication associated with a UE's switching to a PLMN access mode (indication to trigger UE to switch PLMN access mode).

In operation 677, based on the indication associated with a UE's switching to a PLMN access mode (indication to trigger UE to switch PLMN access mode), included in the SoR information, the UE 640 may perform PLMN selection and may deregister from the hosting network.

Although operations 672, 673, 674, and 675 illustrate that the UDM 610 and the SoR-AF 600 operate as separate network entities, the UDM 610 according to an embodiment may solely perform operations 672, 673, 674, and 675. That is, the SoR-AF 600 may be included optionally, and when the SoR-AF 600 is not included separately, the UDM 610 may perform all of the operations described as the operations of the SoR-AF 600.

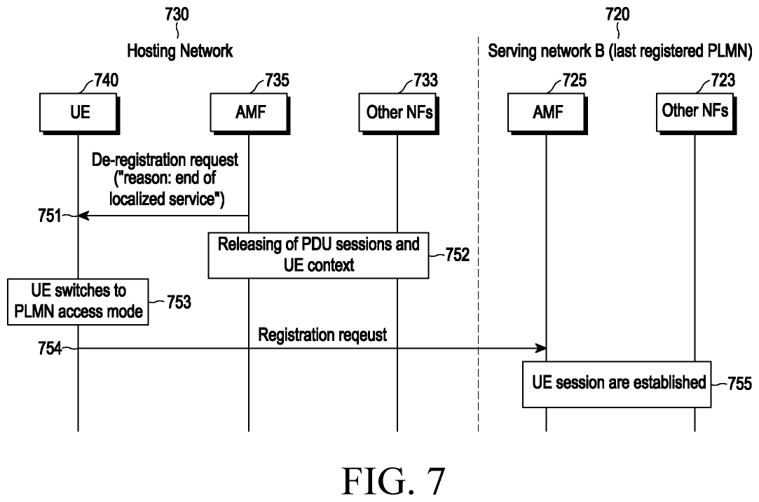

Hereinafter, FIGS. 7 and 8 illustrate the case in which service continuity between a hosting network and a serving network is not supported and the case in which service continuity between the hosting network and the serving network is supported, in the procedure of returning to the serving network or a home network after a steering procedure, which has been described with reference to FIG. 6. That is, the deregistration procedure performed between the UE and the hosting network in operations 676 and 677 of FIG. 6 will be described in detail.

FIGS. 7 and 8 consider returning to a V-PLM (i.e., a last registration serving network before steering to a hosting network), but this procedure is also applicable to the case in which a previous serving network of a UE is its home network and the UE/home network determines that the UE needs to use a service of the hosting network.

FIG. 7 is a flowchart illustrating a procedure in which a UE returns to a serving network or a home network after a steering procedure when service continuity is not supported between a hosting network and the serving network according to an embodiment of the disclosure.

FIG. 7 illustrates operation performed among other NFs 723 and an AMF 725 included in a serving network 720 (i.e., a PLMN with which a UE registered last before the UE is steered to a hosting network), and other NFs 733, an AMF 735, and a UE 740 included in a hosting network 730.

As described above, via operations performed before or up to operation 751, some of the operations illustrated in FIG. 6 may be performed. That is, a UE moves outside a service area of a hosting network, and a home network may perform an operation of determining the UE's returning again to the home network or to a serving network to which the UE registered immediately before UE's steering to the hosting network.

In operation 751, the AMF 735 may transmit, to the UE 740, a deregistration request including “termination of a localized service” or “indication notifying a UE of termination of a localized service” based on the termination of the localized service. The hosting network is capable of transmitting the request to multiple UEs at the same time and thus, the hosting network may also include a timer. After the timer, a UE may attempt to register with a previous serving network in order to manage a serving network load.

In operation 752, the AMF 735 and other NFs 733 may release a PDU session and a UE context. The hosting network may release all PDU sessions and resources reserved to serve the UE, similarly to regular deregistration.

In operation 753, the UE 740 may exit an SNPN access mode/localized service access mode, and may switch to a PLMN access mode. That is, based on a reason (included in the deregistration request) received from the network, the UE 740 may exit the localized service access mode and may attempt network selection again. According to an embodiment, the UE 740 may start selecting a new network again only after the timer provided in operation 751 expires.

In operation 754, the UE 740 may request registration with the previous serving network 720 (or the home network of the UE). That is, the UE 740 may register with a new network, and may request a PDU session again for accessing a service of the network. In operation 755, the AMF 725 of the serving network 720 may establish a UE session with the other NFs 723. That is, the sessions of the UE may be established in the serving network.

FIG. 8 is a flowchart illustrating a procedure in which a UE returns to a serving network or a home network after a steering procedure when service continuity is supported between a hosting network and the serving network according to an embodiment of the disclosure.

FIG. 8 is a flowchart illustrating a procedure in which a UE returns to a serving network or a home network after a steering procedure when service continuity is supported between a hosting network and the serving network according to an embodiment of the disclosure.

FIG. 8 illustrates operation performed among other NFs 823, an AMF 825, and an RAN 828 included in a serving network 820 (i.e., a PLMN with which a UE registered last before the UE is steered to a hosting network), and other NFs 833, an AMF 835, and a UE 840 included in a hosting network 830.

As described above, via operations performed before or up to operation 851, some of the operations illustrated in FIG. 6 may be performed. That is, a UE moves outside a service area of a hosting network, and a home network may perform an operation of determining the UE's returning again to the home network or to a serving network to which the UE registered immediately before the UE's steering to the hosting network.

FIG. 8 is the case in which service continuity is supported between the hosting network 830 and the serving network 820. In this instance, the UE 840 is notified of termination of a localized service by the hosting network 830, and the hosting network 830 may transmit, to the UE 840, information and/or an indication indicating that service continuity is supported between the hosting network 830 and the serving network 820. Therefore, the UE 840 may start cell scanning in the background and may perform UE-supported inter-network handover (here, the UE 840 provides information associated with source and target networks to an RAN 828).

In operation 851, the AMF 835 of the hosting network 830 may transmit a NAS request message to the UE 840. The request may include a reasonable reason and indication leading the UE to perform inter-network handover (handover from the hosting network 830 to the serving network 820).

In operation 852, the RAN of the hosting network 830 may indicate handover to a cell of the serving network 820. After receiving the notification, the UE 840 may determine to switch to the serving network 820. The UE 8 may transmit an appropriate AN parameter to perform handover. Internally, the UE 840 may switch from a localized service mode/SNPN access mode to a PLMN access mode again.

In operation 853, the hosting network 830 and the serving network 820 may switch a UE context and session. The hosting network 830 and the serving network 820 may perform other handover-related procedures in order to switch the UE's session and context.

In operation 854, the UE 840 may need to register again with the previous serving network 820 by transmitting a registration request. Additionally/alternatively, according to an embodiment, the UE 840 may need to register again with the home network by transmitting a registration request.

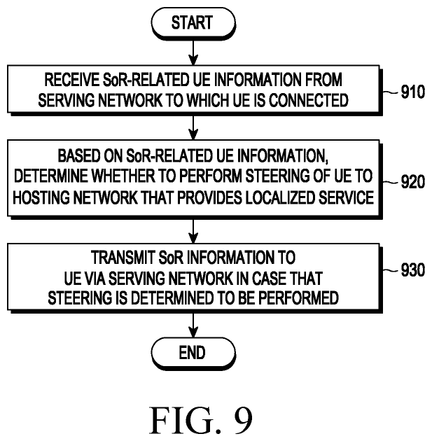

FIG. 9 is a diagram illustrating operation of a network entity according to an embodiment.

The network entity of FIG. 9 may be one of a steering of roaming—application function (SoR-AF), a 3^{rd} party application function (AF) or a unified data management (UDM) included in a home network.

In operation 910, the network entity included in the home network may receive a first steering of roaming (SoR)-related UE information from a serving network to which a UE is connected.

In operation 920, the network entity may determine, based on the first SoR-related UE information, whether to perform steering of the UE to a hosting network that provides a localized service. According to an embodiment, the first SoR-related UE information may include at least one of a current location of the UE, the number of UEs existing in an area of interest configured by the home network, the experienced throughout of the UE, and the quality of service (QoS).

According to an embodiment, to determine whether to perform steering of the UE to the hosting network that provides the localized service, the network entity may determine whether the UE moves into an area of the localized service, and, when the UE moves into the area of the localized service, may determine, based on the first SoR-related UE information, whether to perform steering of the UE to the hosting network that provides the localized service.

In operation 930, when steering of the UE to the hosting network that provides the localized service is determined to be performed, the network entity may transmit first SoR information to the UE via the serving network. The first SoR information may include an indication associated with the UE's switching to a localized service access mode. According to an embodiment, the first SoR information may include information associated with the hosting network, and the information associated with the hosting network may include at least one of a stand-alone non-public network identifier (SNPN ID) list, location validity information, and time validity information. According to an embodiment, the first SoR information may include information associated with whether service continuity is supportable between the hosting network and the serving network.

According to an embodiment, when the UE moves outside the area of the localized service or when a predetermined time period of the localized service expires, the network entity may receive second SoR-related UE information from the hosting network. The network entity may determine, based on the second SoR-related UE information, whether to perform steering of the UE connected to the hosting network to the home network or the serving network. The network entity may transmit second SoR information to the UE via the serving network when determining to perform the steering of the UE to the home network or the serving network. According to an embodiment, the second SoR information may include an indication associated with the UE's switching to a public land mobile network (PLMN) access mode. According to an embodiment, the second SoR information may include an indicator associated with whether service continuity is maintained between the hosting network and the serving network.

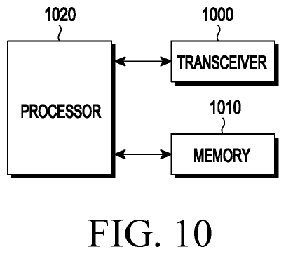

FIG. 10 is a diagram illustrating a structure of a network entity according to an embodiment of the disclosure.

The network entity of FIG. 10 may be one of a steering of roaming—application function (SoR-AF), a 3^{rd} party application function (AF) or a unified data management (UDM) included in a home network.

The network entity according to an embodiment of the disclosure may include a processor 1020 to control the overall operation of the network entity, a transceiver 1000 including a transmitter and a receiver, and memory 1010. As a matter of course, the network entity is not limited to the example, and may include fewer or more number of components than the components of FIG. 10.

According to an embodiment of the disclosure, the transceiver 1000 may perform signal transmission or reception with network entities or another network node. Signals transmitted or received to/from the network entity may include control information and data. In addition, the transceiver 1000 may receive a signal via a wireless channel and output the same to the processor 1020, and may transmit a signal output from the processor 1020 via a wireless channel.

According to an embodiment of the disclosure, the processor 1020 may control the network entity to perform any one operation in the above-described embodiments. The processor 1020, the memory 1010, and the transceiver 1000 may not be necessarily embodied as separate modules, and may also be embodied as a single configuration such as a single chip. The processor 1020 and the transceiver 1000 may be electronically connected. In addition, the processor 1020 may be an application processor (AP), a communication processor (CP), a circuit, an application-specific circuit, or at least one processor.

According to an embodiment, the memory 1010 may store data such as a basic program, an application program, configuration information, and the like for operating the network entity. Particularly, the memory 1010 may provide data stored therein by request from the processor 1020. The memory 1010 may be embodied as a storage medium such as ROM, RAM, a hard disk, CD-ROM, a DVD, and the like, or a combination of storage media. In addition, a plurality of pieces of memory 1010 may be present. In addition, the processor 1020 may perform the above-described embodiments based on a program for performing the above-described embodiments of the disclosure stored in the memory 1010.

It should be noted that the above-described configuration diagrams, illustrative diagrams of control/data signal transmission methods, illustrative diagrams of operation procedures, and structural diagrams are not intended to limit the scope of the disclosure. That is, all the constituent elements, entities, or operation steps described in the embodiments of the disclosure should not be construed as being essential elements for the implementation of the disclosure, and even though including only some of the elements, the disclosure may be implemented without impairing the true of the disclosure. Also, the above respective embodiments may be employed in combination, as necessary. For example, the methods proposed in the disclosure may be partially combined with each other to operate a network entity and a terminal.

The above-described operations of a base station or terminal may be implemented by providing any unit of the base station or terminal device with a memory device storing corresponding program codes. That is, a controller of the base station or terminal device may perform the above-described operations by reading and executing the program codes stored in the memory device by means of a processor or central processing unit (CPU).

Various units or modules of an entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

When implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. That is, it will be apparent to those skilled in the art that other variants based on the technical idea of the disclosure may be implemented. Also, the above respective embodiments may be employed in combination, as necessary. As an example, the methods proposed in the disclosure may be partially combined with each other to operate a base station and a terminal. Moreover, although the above embodiments have been described based on the 5G or NR system, other variants based on the technical idea of the embodiments may also be implemented in other communication systems such as LTE, LTE-A, or LTE-A-Pro systems.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method by a network entity included in a home network in a wireless communication system, the method comprising:
receiving, from a serving network to which a terminal is connected, first steering of roaming (SoR)-related terminal information;
determining, based on the first SoR-related terminal information, whether to perform steering of the terminal to a hosting network that provides a localized service; and
in case that steering of the terminal to the hosting network is determined to be performed, transmitting, to the terminal via the serving network, first SoR information,
wherein the first SoR information includes an indication indicating the terminal to switch to a localized service access mode.

2. The method of claim 1, wherein the first SoR information includes information associated with the hosting network, and
wherein the information associated with the hosting network includes at least one of a stand-alone non-public network identifier (SNPN ID) list, location validity information, and time validity information.

3. The method of claim 2, wherein the first SoR information includes information associated with whether service continuity is supportable between the hosting network and the serving network.

4. The method of claim 1, wherein the first SoR-related terminal information includes at least one of a current location of the terminal, a number of terminals existing in an area of interest configured by the home network, an experience throughout of the terminal, and a quality of service (QoS).

5. The method of claim 1, wherein the determining of whether to perform steering of the terminal to the hosting network that provides the localized service, comprises:
determining whether the terminal moves into an area of the localized service; and
in case that the terminal moves into the area of the localized service, determining, based on the first SoR-related terminal information, whether to perform steering of the terminal to the hosting network that provides the localized service.

6. The method of claim 1, comprising:
in case that the terminal moves outside the area of the localized service or in case that a predetermined time period of the localized service expires, receiving second SoR-related terminal information from the hosting network;
determining, based on the second SoR-related terminal information, whether to perform steering of the terminal connected to the hosting network to the home network or the serving network; and
transmitting, to the terminal, second SoR information via the serving network in case that the steering of the terminal to the home network or the serving network is determined to be performed,
wherein the second SoR information includes an indication associated with the terminal's switching to a public land mobile network (PLMN) access mode.

7. The method of claim 6, wherein the second SoR information includes an indicator associated with whether service continuity is supportable between the hosting network and the serving network.

8. The method of claim 1, wherein the network entity is one of a steering of roaming-application function (SoR-AF) included in the home network, a 3^{rd} party application function (AF), or a unified data management (UDM).

9. A network entity included in a home network in a wireless communication system, the network entity comprising:
a transceiver; and
at least one processor,
wherein the at least one processor is configured to:
receive, from a serving network to which a terminal is connected, first steering of roaming (SoR)-related terminal information;
determine, based on the first SoR-related terminal information, whether to perform steering of the terminal to a hosting network that provides a localized service; and
transmit, to the terminal via the serving network, first SoR information, in case that steering of the terminal to the hosting network is determined to be performed, and
wherein the first SoR information includes an indication indicating the terminal to switch to a localized service access mode.

10. The network entity of claim 9, wherein the first SoR information includes information associated with the hosting network, and
wherein the information associated with the hosting network includes at least one of a stand-alone non-public network identifier (SNPN ID) list, location validity information, and time validity information.

11. The network entity of claim 10, wherein the first SoR information includes whether service continuity is supportable between the hosting network and the serving network.

12. The network entity of claim 9, wherein the first SoR-related terminal information includes at least one of a current location of the terminal, a number of terminals existing in an area of interest configured by the home network, an experienced throughput of the terminal, and a quality of service (QoS).

13. The network entity of claim 9, wherein the at least one processor is configured to determine whether the terminal moves into an area of the localized service; and
in case that the terminal moves into the area of the localized service, determine, based on the first SoR-related terminal information, whether to perform steering of the terminal to the hosting network that provides the localized service.

14. The network entity of claim 9, wherein the at least one processor is configured to:
in case that the terminal moves outside the area of the localized service or in case that a predetermined time period of the localized service expires, receive second SoR-related terminal information from the hosting network, and determine, based on the second SoR-related terminal information, whether to perform steering of the terminal connected to the hosting network to the home network or the serving network; and
in case that whether to perform steering of the terminal to the home network or the serving network is determined, transmit second SoR information to the terminal via the serving network, and
wherein the second SoR information includes an indication associated with the terminal's switching to a public land mobile network (PLMN) access mode, and an indication associated with whether service continuity between the hosting network and the serving network is maintained.

15. The network entity of claim 9, wherein the network entity is one of a steering of roaming-application function (SoR-AF) included in the home network, a 3^{rd} party application function (AF), or a unified data management (UDM).
